(19) United States
(12) Patent Application Publication
(10) Pub. No.: US 2010/0321641 A1
(43) Pub. Date: Dec. 23, 2010

(54) LIGHT MODULE DEVICE

(75) Inventor: Marcellus Jacobus Johannes Van Der Lubbe, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/865,453

(22) PCT Filed: Feb. 2, 2009
(86) PCT No.: PCT/IB09/50394

§ 371 Date: Jul. 30, 2010

(30) Foreign Application Priority Data
Feb. 8, 2008 (EP) 08151211.3

(51) Int. Cl. H04N 9/31; F21V 9/00; F21V 9/16; F21V 5/00

(52) U.S. Cl. 353/31; 362/235; 362/84; 362/231; 353/121

(57) ABSTRACT

This invention relates to illumination systems for projection type display systems, and more particularly to a light module device comprising a light source, which emits light of a first color, and a pixelated optical element, which is arranged to receive the emitted light. The pixelated optical element comprises a first set of pixels for color converting a fraction of the emitted light of the first color into a second color, a second set of pixels for color converting a fraction of the emitted light of the first color to a third color, and a third set of pixels which are non-converting for passing a fraction of the emitted light. The device further comprises an addressable pixelated optical shutter arranged in front of the pixelated optical element for modulating light received from the pixelated optical element and as a result outputs light from said device, which output light comprises light of three colors which are modulated by the addressable pixelated optical shutter.

### FIELD OF THE INVENTION

The present invention generally relates to illumination systems for projection type display systems, and more particularly to a light module device.

### BACKGROUND OF THE INVENTION

It is known to use light emitting diodes (LEDs) in lighting applications such as projectors for displaying images on a projection screen or similar surface for the view of a user. Typically, in current LED projectors, two or three LED modules in the primary colors red, green, and blue are utilized and replace the UHP lamp and color filters or color wheel previously used in projector systems based on liquid crystal displays (LCD) and digital light processing (DLP) projection systems, respectively. The DLP projection system is a type of LED projector that has become popular in the recent years. In these systems the image is created by illuminating a Digital Micro-mirror Device (DMD), which is a matrix of microscopically small controllable mirrors on a semiconductor chip, and projecting an image formed on the DMD on a screen. The individual mirror on the DMD represents one pixel (or more) in the projected image and typically has two states, one state when reflecting the incoming light through a lens to the screen, and one state when reflecting the incoming light to a heat sink such that the pixel that the mirror is representing in the projected image is not lit.

A LED-based light engine for a DLP system (MP-P300) provided by Samsung comprises two separate light sources: one green light emitting LED source, and one red and blue light emitting LED source. The colors are driven sequentially. In the light engine, the two light sources are directed into one focal point for illuminating the DMD. Shaping, color mixing and directing of light in the light path without loss of light is achieved with a plurality of lenses, dichroic mirrors and a lens array. Together with heat pipes for cooling the individual light sources this consumes a considerable amount of valuable space in the projector system.

### SUMMARY OF THE INVENTION

It is an object of the present invention to provide a light module device and a method for providing light in a projector that alleviates the above-mentioned drawbacks of the prior art.

This object is achieved by a device and a method according to the present invention as defined in claims 1 and 14.

The invention is based on an insight that by utilizing a one-colored light source, and converting fractions of that light into other colors which multicolored light is then optically modulated to provide a required light output, a full color light module device is achieved that requires fewer optical components, and have a spatially limited heat spreading device compared to full color light module devices comprising several light sources of separate colors.

Thus, in accordance with an aspect of the present invention, there is provided a light module device comprising at least one light source emitting light of a first color, and a pixelated optical element arranged to receive the emitted light. The pixelated optical element comprises a first set of pixels for color converting a fraction of the emitted light of the first color into a second color, a second set of pixels for color converting a fraction of the emitted light of the first color to a third color, and a third set of pixels which are non-converting for passing a fraction of the emitted light. The first, second and third sets of pixels comprise at least one pixel each. The device further comprises an addressable pixelated optical shutter arranged in front of the pixelated optical element for modulating light received from the pixelated optical element resulting in a light output from the device.

Thus, there is provided a light module device in which a light source of a single color is conveniently utilized to produce light of a second and a third color. The color converting optical element in the present invention is constituted by two color converting sets of pixels and a third set of non-converting pixels which sets together provide light of three colors. This light is spatially distributed such that the addressable pixelated optical shutter, which is arranged in front of the optical element, then conveniently addresses selected pixels and thus blocks or transmits light of a first, second and a third color with each pixel, respectively. This advantageously reduces the need for light sources of different (primary) colors which typically are used in prior art light module devices for projecting/displaying colored images.

In accordance with an embodiment of the device, as defined in claim 2, the addressable pixelated optical shutter is arranged to modulate light by sequentially transmitting light received from the respective sets of pixels.

Providing sequentially transmitting light of the first, second and third color is advantageous for display applications like e.g. digital processing projection system.

In accordance with an embodiment of the device, as defined in claim 3, phosphors are arranged on the first and second sets of pixels for the color converting optical element. By using phosphors for color converting the light of the first color, a large number of different colors are obtainable. Furthermore, using phosphors allows for providing small pixels of the color converting optical element, which is advantageous for high resolution applications.

In accordance with an alternative embodiment of the device, as defined in claim 4, the device further comprises at least one second light source emitting light of a fourth color. This is convenient when realizing a large number of colors in the color converting optical element, and when having color converting areas which are activated by light of different wavelengths.

In accordance with an embodiment of the device, as defined in claim 5, the device further comprises a lens array. The lens array is preferably arranged directly in connection to the optical shutter and allows for the light output from the optical shutter to be collimated, which is advantageous.

In accordance with an embodiment of the device, as defined in claim 6, the device further comprises a heat sink. Since the device according to the present invention comprises at least one light source for producing light of one single color, and the light is forwarded in the device along a common optical path, the light sources (if several) are assembled such that a single heat sink is commonly used for spreading heat from the light sources which in turn is space-saving and thus allows a compact design of the device.

In accordance with an embodiment of the device, as defined in claim 7, the addressable pixelated optical shutter is a liquid crystal cell device, which is advantageous since it offers a well known relatively cheap and easy to handle electro-optical solution for the optical shutter.

In accordance with an embodiment of the device, as defined in claim 8, the light source comprises at least one light emitting diode. Thus the light module device can have one or more light emitting diodes, LEDs, as light source, which is advantageous for several reasons. The LED is known for its small size, low power consumption and long lifetime in comparison with for instance a UHP lamp. By adding a number of LEDs a desired light intensity for the device may be achieved.

In accordance with an embodiment of the device, as defined in claim 9, the pixelated optical element comprises at least one additional set of pixels for color converting a fraction of the emitted light of the first color into an additional color. Thus, there is provided a light module device with the ability to provide any number of required colors of light from the device.

In accordance with an embodiment of the device, as defined in claim 10, the first and second colors are the same color.

In accordance with an embodiment of the invention there is provided a digital light processor projection system as defined in claim 11, which system comprises a light module device as described above, and a digital micro-mirror device. The light module is arranged to, in a light path, provide color sequenced light to the digital micro-mirror device. Utilizing a light module device according to the invention in the projection system offers advantages as described for the light module device above.

In accordance with an embodiment of the system, as defined in claim 12, the system further comprises a mirror arranged in the light path to reflect the color sequenced light from the light module towards the digital micro-mirror device, which is advantageous.

In accordance with an embodiment of the system, as defined in claim 13, the system further comprises a lens device for projecting the colored images, which is advantageous.

In accordance with a second aspect of the invention, as defined in claim 14, there is provided a method for providing light in a digital light processor projector comprising a digital micro-mirror device, the method comprising:

providing light of a first color,

color converting fractions of the light of the first color into light of a second color and light of a third color by illuminating a pixelated optical element comprising a first and a second set of color converting sub areas for the second and the third color, wherein the pixelated optical element further comprises non-converting sub areas for providing a fraction of light of the first color,

providing the fractions of light of the first, second and third color to an addressable pixelated optical shutter,

light modulating the fractions of light of the first, second and third color with the addressable pixelated optical shutter, and

providing the modulated light output from the addressable pixelated optical shutter to the digital micro-mirror device.

Hence there is provided a method for providing light in a digital light processor projector comprising a micro-mirror device, which method utilizes light of a single color of the light source, while providing full color projection for the projector.

In accordance with an embodiment of the method, as defined in claim 15, the step of light modulating the fractions of light of the first, second and third color comprises sequentially transmitting light of the first, second and third color, respectively.

In accordance with an embodiment of the method, as defined in claim 16, phosphors are arranged on the first and second sets of color converting sub areas. Further each sub area comprises at least one pixel.

In accordance with an embodiment of the method, as defined in claim 17, the step of providing the modulated light to the digital micro-mirror device comprises collimating the modulated light.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is an illustration of the light path within an embodiment of a light module device according to the present invention;

FIG. 2 is a cross-sectional view of an embodiment of a light module device according to the present invention;

FIG. 3 is an illustration of a color converting pixelated optical element according to an embodiment of the present invention;

FIG. 4 is a cross-sectional view of an embodiment of a light module device according to the present invention;

FIG. 5 is a cross-sectional view of an embodiment of a digital light processor projection system according to the present invention; and

FIG. 6 is a flowchart illustrating an embodiment of a method according to the present invention.

### DESCRIPTION OF PREFERRED EMBODIMENTS

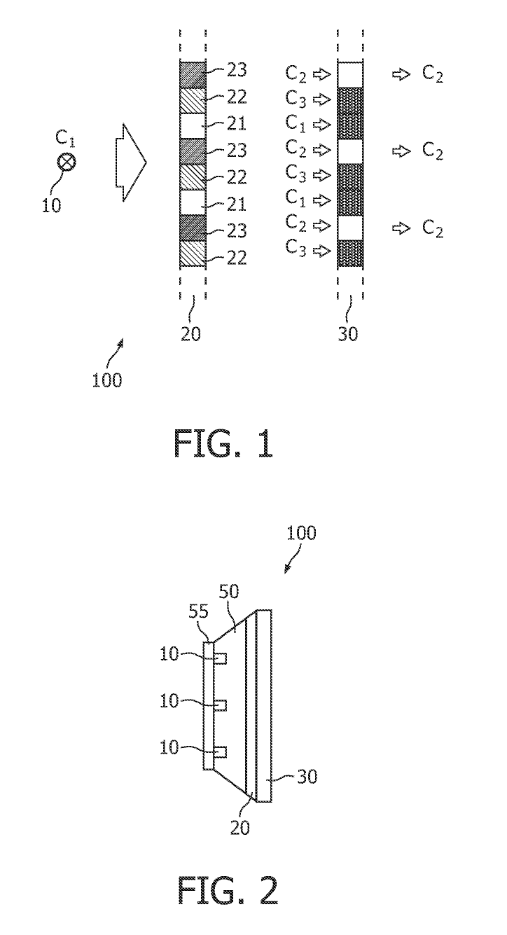

According to a first embodiment of the invention there is provided a light module device, which is herein after referred to as a “CLM” (compact light module). An illustration of the principle structure and light modulation of the CLM is depicted in FIG. 1. The CLM 100 comprises a light source 10 which emits light of a first color C1, a pixelated optical element 20 which is arranged to receive the light that is emitted from the light source 10, and an addressable pixelated optical shutter 30, herein after referred to as the optical shutter, arranged in front of the pixelated optical element 20 and from which optical shutter 30 modulated light is output from the CLM 100.

The pixelated optical element 20, herein after referred to as the optical element, comprises sub areas with color converting functionality as well as non-converting sub areas. More specifically, the optical element 20 has non-converting pixels 21 through which light from the light source 10 passes, and pixels for color converting light of the first color C1 into a second color C2, 22, and pixels for color converting light of the first color C1 into a third color C3. Thus, when light of color C1 illuminates the optical element 20, a spatially distributed light source of a total of three colors C1, C2, and C3 is provided.

In an alternative embodiment the colors C1 and C2 are the same color and a spatially distributed light source of two colors is provided.

Furthermore, the optical shutter 30 is addressed in a desired way so as to selectively modulate the light output from the CLM 100. In the illustration in FIG. 1, light from pixels 21 and 22 is blocked and as a consequence only light of color C2 is output from the CLM 100.

With reference to FIG. 2, an embodiment of the CLM 100 comprises a plurality of light sources 10. This increases the intensity of light of the first color C1, which in turn increases the light output from the color converting optical element 20 (i.e. light of colors C1,

C2, and C3) and the optical shutter 30, hence consequently increasing the light output from the CLM 100. This is possible without changing the aperture of the CLM 100. The light sources 10 are arranged on a substrate 55. Furthermore, a reflector 50 shaped as a cone truncated parallel to its base is arranged such that it encompasses the light sources 10 to reflect light laterally emitted from the light sources 10 and to reflect backscattered light from the optical element 20. The optical element 20 is arranged at the base of the reflector 50, and the substrate 55 is arranged at the opposite end of the reflector 50. In this embodiment the optical shutter 30 abuts on the optical element 20.

In an alternative embodiment the optical shutter 30 and the optical element 20 are distanced. A waveguide, filter, optical component or material may be arranged in between the optical element 20 and the optical shutter 30.

In an embodiment of the CLM 100 the optical shutter 30 is realized with a liquid crystal cell device, i.e. a liquid crystal shutter. A liquid crystal shutter typically comprises a liquid crystal layer sandwiched between crossed polarizers and glass or polymer substrates, and is furthermore arranged having an addressable electrode matrix, i.e. pixels. The liquid crystal layer is oriented in such a way that at least two states of light modulation are achievable for each pixel: one transmitting state and one blocking state. One of these states typically occurs when the pixel is connected to voltage, and the other state occurs when no voltage (or alternatively a second voltage) is applied to the pixel. As a person skilled in the art is aware of, there are numerous of variants of LC-shutters, and also corresponding electro-optical shutters utilizing alternative techniques yet having the same functionality as an optical component, available on the market. These constitute adequate alternatives for realizing the optical shutter and are considered to fall within the scope and spirit of the present invention and will not be discussed further here.

In the embodiment of the CLM 100, as described above, the light source 10 comprises at least one light emitting diode, LED. Light of the first color C1, BLUE, is emitted from a state of the art LED array. As mentioned above, a number of light sources can be added so as to obtain a desired intensity of the light output from the CLM 100.

The color C1 emitted by the light source 10 is preferably a primary color. This is directly generated by the LED chip. In an alternative embodiment the light of color C1 is generated indirectly by using phosphor converting LEDs in the light source 10.

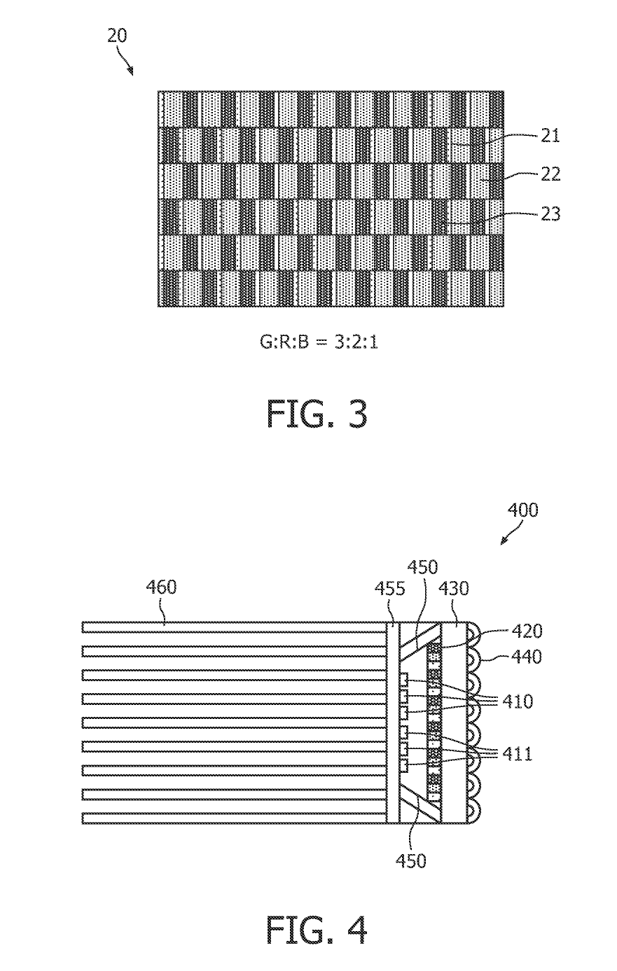

An illustrative example of the optical element 20 is shown in FIG. 3. The optical element 20 is here arranged with three sets of pixels providing light of the colors BLUE 21, GREEN 22, and RED 23. The sizes for pixels 21-23 in the example are arranged having the proportions GREEN:RED:BLUE=3:2:1. Thus a sub area for providing green light 22 is three times bigger than a sub area for providing blue light 21, while a sub area for providing red light 23 is two times bigger than a sub area for providing blue light 21. The individual sub area size, pixel size, shape and distribution over the optical element 20 is preferably optimized for each application. In areas close to the edges of the optical element 20, the incident light is fading due to the distribution of the light emitted from the light sources 10 which can be compensated by increasing the chosen pixel size in these regions to gain more light from each sub area.

The provided colors C1, C2, and C3 of the light output from the CLM 100 are typically distinct primary colors such as the combination red (R), green (G) and blue (B). As is recognized by a man skilled in the art other color combinations and number of colors are possible to realize with the light module device and thus falls within the scope and spirit of the present invention.

In an embodiment of a CLM 400 according to the present invention, as depicted in FIG. 4, a state of the art LED array 410, which LED array is present for emitting light capable of activating the color converting areas of an optical element 420 which is arranged in the CLM 400, and a blue LED array 411 are arranged with dies assembled on a substrate 455. Further, a heat sink 460 is attached to the opposite side of the substrate by means of for instance soldering or gluing. Alternatively the dies may be provided directly onto the heat sink 460. The heat sink 460 enables heat management for cooling the light sources 410. The heat sink 460 is arranged directly behind the light sources 410 of the CLM 400, thus there is no need for expensive heat pipe constructions to transfer heat from each separate light source 410 to a distanced heat spreader and fan.

Furthermore, a reflector 450 shaped as a cone truncated parallel to its base is arranged such that it encompasses the light sources 10. The optical element 420 is arranged at the base of the reflector 450 such that light emitted from the light sources 410 illuminates the optical element 420. The substrate 455 is arranged at the opposite end of the reflector 450. In this embodiment the optical shutter 430 abuts the optical element 420. The optical shutter 430 is furthermore on the opposite side from the optical element 420 provided with a lens array 440 for collimation of the light output from the optical shutter 430.

The optical element 420 comprises sub areas provided with red and green remote phosphor. These sub areas correspond to sub areas 22 and 23 respectively as described previously and as illustrated in FIGS. 1 and 3. The sub areas are printed in a defined color matrix. When light from the LED Array 410 illuminates the optical element 420 the light activates the red and green remote phosphors in sub areas 22 and 23 such that red and green light is reemitted from these sub areas.

Further, the optical element 420 is provided with transparent windows, which transparent windows correspond to sub areas 21 as described previously and as illustrated in FIGS. 1 and 3. A fraction of the light emitted from the blue light LED array 411 projects through these windows. A fraction of the light emitted from the LED array 410 will also project through these windows. However, this light may be chosen for instance to have the same color as LED array 410, or alternatively have a non-visible wavelength. The optical element 420 thus provides light of red color, green color and blue color. The addressable pixelated optical shutter 430 receives light emitted from and transmitted through the optical element 420. The optical shutter 430 is arranged to modulate the light output from the CLM 400 by for each pixel position and for each moment in time either transmitting or blocking light output from the optical element 420. The optical shutter 430 is controlled by a controller with suitable projector control software (not shown).

As described above the optical element 420 provides light of red color, green color and blue color. When controlling the optical shutter 430 such that several colors are transmitted at the same time, color mixing is achieved.

In an embodiment of the CLM 400 the optical shutter 430 is addressed such as to sequentially transmit light of each individual color provided by the optical element 420. The pattern of the sequence may take different shapes. Typically, the light output from the CLM can change in time according to:

RED-GREEN-BLUE-RED-GREEN-BLUE-RED-GREEN-BLUE, or

RED-BLUE-GREEN-RED-BLUE-GREEN-RED-BLUE-GREEN, or

RED-BLUE-RED-GREEN- RED-BLUE-RED-GREEN- RED-BLUE-RED-GREEN, and so on. The frequency/time and sequence for output of each color depends on the current application. The minimum switching time of the optical shutter 430 will limit the frequency of switching colors output from the device.

In alternative embodiments the optical shutter 430 is controlled so as to provide different color mixing, and/or single color modulation for separate fractions of the light output area of the CLM 400, i.e. the area of the pixelated optical shutter 430. The light output area from the CLM is in an alternative embodiment divided so as to provide one light path for red light, one light path for green light and one light path for blue light. The light paths for each individual color are separated in space.

In an alternative embodiment of the present invention, the CLM 400 is further arranged with a lens array 440, which is arranged to collimate the light output from the optical shutter 430. The lens array 440 is in this exemplifying example a lens led array foil, which is glued onto the optical shutter 430.

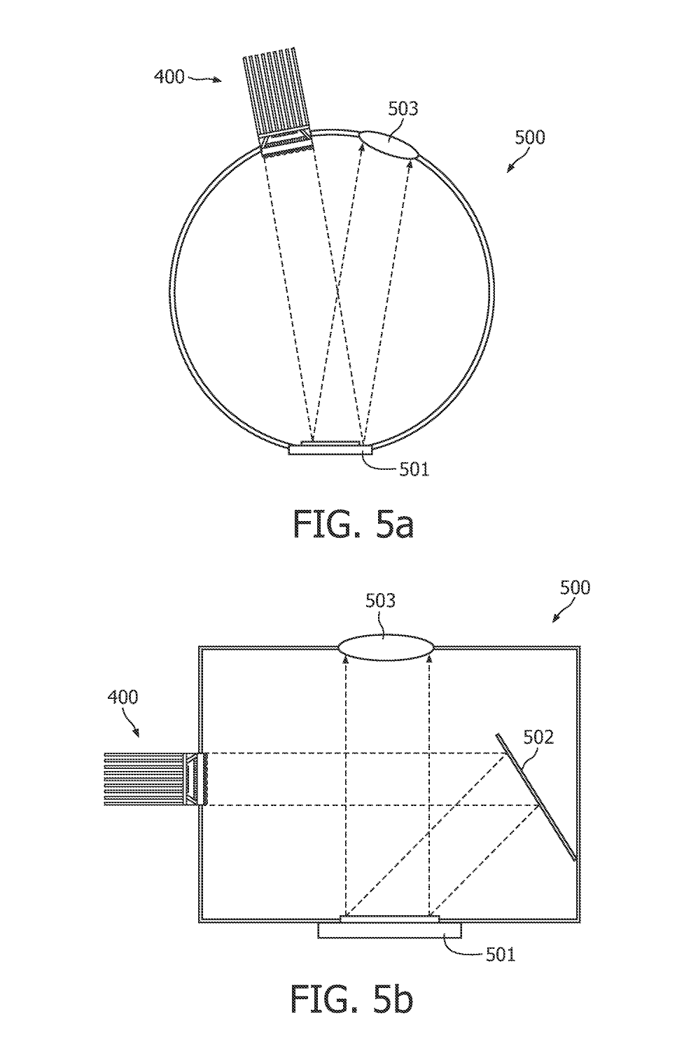

According to an embodiment of the present invention a CLM 400 is comprised within a digital light processor projection system 500 (DLP). The light output from the CLM 400 is projected directly upon a digital micro-mirror device 501, FIG. 5a. In an alternative embodiment, a reflecting mirror 502 is arranged in the light path of the CLM 400 to reflect light output from the CLM to a digital micro-mirror device (DMD) 501, as depicted in FIG. 5b. In the CLM 400 according to the present invention, all excessive features needed for beam shaping, color mixing, and directing three color beams onto the reflecting mirror 502 (or alternatively the DMD 501) as in prior art are not necessary, thus allowing for a compact design of the projection system 500.

The total thickness of the CLM 400 according to the present invention is less than 5 mm. The CLM is down scalable without loss of features, to smaller DLP sizes (0.44 inch) and is also applicable for cell phone applications. The CLM 400 is also applicable in alternative projection systems.

In an alternative embodiment of the CLM, the optical shutter 430, which is realized with any appropriate electro-optical technique, is utilized to create local dimming of the output of the CLM 400. By tuning the light output locally by means of sequentially addressing the optical shutter 430, local dimming is gained like in a conventional liquid crystal display back light. This feature improves the contrast and therefore picture quality when the CLM 100 is utilized in a digital light processor projection system 500 according to the present invention.

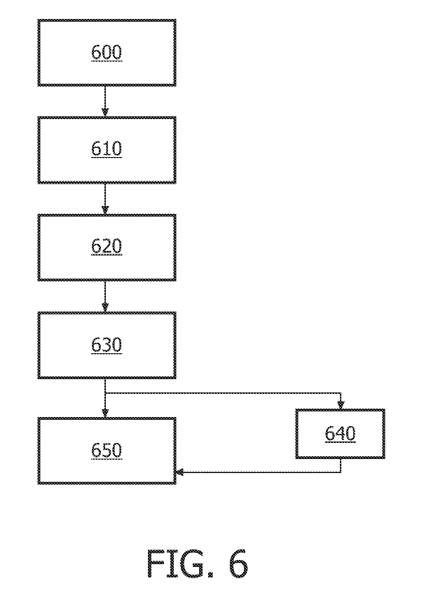

An embodiment of a method for providing light in a digital light processor projector comprising a digital micro-mirror device, is illustrated in FIG. 6. In Box 600 there is provided light of a first color. The method continues with color converting fractions of said light of said first color into light of a second color and light of a third color, Box 610. This is done by illuminating a pixelated optical element comprising a first and a second set of color converting sub areas for the second and third color. The pixelated optical element further comprises non-converting sub areas for providing a fraction of light of the first color. Further on, in Box 620 the fractions of light of the first, second, and third color are provided to an addressable pixelated optical shutter. In Box 630 the light is light modulated with the addressable pixelated optical shutter, and finally in Box 650 the modulated light is provided to the digital micro-mirror device.

In an alternative embodiment of the method, the step of light modulating the light which is outputted in Box 610, i.e. when light of three different colors has been provided by means of color conversion and transmission, respectively, comprises sequential transmission of light of the first, second and third color, respectively.

In an embodiment of the method according to the present invention, the step of providing the modulated light to the digital micro-mirror device comprises collimating the modulated light, Box 640.

Above, embodiments of the device and method according to the present invention as defined in the appended claims have been described. These should be seen as merely non-limiting examples. As understood by a skilled person, many modifications and alternative embodiments are possible within the scope of the invention.

It is to be noted, that for the purposes of this application, and in particular with regard to the appended claims, the word “comprising” does not exclude other elements or steps, that the word “a” or “an”, does not exclude a plurality, which per se will be apparent to a person skilled in the art.

1. A light module device comprising:
at least one light source emitting light of a first color;
a pixelated optical element arranged to receive said emitted light, said pixelated optical element comprising a first set of pixels for color converting a fraction of said emitted light of said first color into a second color, a second set of pixels for color converting a fraction of said emitted light of said first color to a third color, and a third set of pixels which are non-converting for passing a fraction of said emitted light, said first, second and third sets of pixels comprising at least one pixel each; and
an addressable pixelated optical shutter arranged in front of said pixelated optical element for modulating light received from said pixelated optical element resulting in a light output from said device, by sequentially transmitting light of said first, second, and third color.

2. (canceled)

3. A light module device according to claim 1, wherein phosphors are arranged on said first and second sets of pixels for said color converting optical element.

4. A light module device according to claim 1, further comprising at least one second light source emitting light of a fourth color.

5. A light module device according to claim 1, further comprising a lens array.

6. A light module device according to claim 1, further comprising a heat sink.

7. A light module device comprising a light module according to claim 1, wherein said addressable pixelated optical shutter is a liquid crystal cell device.

8. A light module device according to claim 1, wherein said light source comprises at least one light emitting diode.

9. A light module device according to claim 1, wherein said pixelated optical element comprises at least one additional set of pixels for color converting a fraction of said emitted light of said first color into an additional color.

10. A light module device according to claim 1, wherein said first and second colors are the same color.

11. A digital light processor projection system comprising a light module device according to claim 1, and a digital micro-mirror device, wherein said light module device is arranged to, in a light path, sequentially transmit light of said first, second, and third color to said digital micro-mirror device.

12. A digital light processor projection system according to claim 11, further comprising a mirror arranged in said light path to reflect said color sequenced light from said light module device towards said digital micro-mirror device.

13. A digital light processor projection system according to claim 12, further comprising a lens device for projecting said colored images.

14. A method for providing light in a digital light processor projector comprising a digital micro-mirror device, said method comprising:
providing light of a first color;
color converting fractions of said light of said first color into light of a second color and light of a third color by illuminating a pixelated optical element comprising a first and a second set of color converting sub areas for said second and said third color, wherein said pixelated optical element further comprises non-converting sub areas for providing a fraction of light of said first color;
providing said fractions of light of said first, second and third color to an addressable pixelated optical shutter;
light modulating said fractions of light of said first, second and third color with said addressable pixelated optical shutter:
providing said modulated light output from said addressable pixelated optical shutter to said digital micro-mirror device.

15. A method according to claim 14, wherein said step of light modulating said fractions of light of said first, second and third color comprises sequentially transmitting light of said first, second and third color, respectively.

16. A method according to claim 14, wherein phosphors are arranged on said first and second sets of color converting sub areas, and wherein each sub area comprises at least one pixel.

17. A method according to claim 14, wherein said step of providing said modulated light to said digital micro-mirror device comprises collimating said modulated light.
